(19) United States
(12) Patent Application Publication
(10) Pub. No.: US 2020/0223291 A1
(43) Pub. Date: Jul. 16, 2020

(54) TRANSPORT REFRIGERATION UNIT WITH A RENEWABLE WIND-ENERGY SOURCE

(71) Applicant: Carrier Corporation, Palm Beach Gardens, FL (US)

(72) Inventor: Michael Thomas Swab, Acworth, GA (US)

(21) Appl. No.: 16/644,092

(22) PCT Filed: Sep. 6, 2018
(86) PCT No.: PCT/US2018/049746

§ 371 Date: Mar. 3, 2020

Related U.S. Application Data
(60) Provisional application No. 62/554,696, filed on Sep. 6, 2017.

(51) Int. Cl. B60H 1/32; B60H 1/00

(52) U.S. Cl. CPC B60H 1/3232; B60P 3/20; B60H 1/00428

(57) ABSTRACT

A transport refrigeration unit includes at least one airfoil (88) and an energy conversion device (90) attached to the at least one airfoil. The at least one airfoil is adapted to mechanically drive the energy conversion device upon exposure to wind (105). The energy conversion device is constructed to convert mechanical energy to electrical energy, and the electrical energy is used, at least in-part, to charge the battery (52). An isolation relay (108) is controlled by the controller (82). A capacitor bank (110) and a rectifier (112) are provided.

### BACKGROUND

The present disclosure relates to a transport refrigeration unit and, more particularly, to renewable wind-energy source of the transport refrigeration unit.

Traditional refrigerated cargo trucks or refrigerated tractor trailers, such as those utilized to transport cargo via sea, rail, or road, is a truck, trailer or cargo container, generally defining a cargo compartment, and modified to include a refrigeration system located at one end of the truck, trailer, or cargo container. Refrigeration systems typically include a compressor, a condenser, an expansion valve, and an evaporator serially connected by refrigerant lines in a closed refrigerant circuit in accord with known refrigerant vapor compression cycles. A power unit, such as a combustion engine, drives the compressor of the refrigeration unit, and may be diesel powered, natural gas powered, or other type of engine. In many tractor trailer transport refrigeration systems, the compressor is driven by the engine shaft either through a belt drive or by a mechanical shaft-to-shaft link. In other systems, the engine of the refrigeration unit drives a generator that generates electrical power, which in-turn drives the compressor.

When the cargo container is generally stored, and the TRU sits idle for long periods of time, a battery of the TRU may become drained or depleted thus hindering the ability to start the TRU when needed. Moreover, and with current environmental trends, improvements in transport refrigeration units are desirable particularly toward aspects of environmental impact. With environmentally friendly refrigeration units, improvements in reliability, cost, and weight reduction are also desirable.

### SUMMARY

A transport refrigeration unit according to one, non-limiting, embodiment of the present disclosure includes at least one airfoil; an energy conversion device attached to the airfoil, wherein the at least one airfoil is constructed and arranged to mechanically drive the energy conversion device upon exposure to wind, the energy conversion device is constructed and arranged to convert mechanical energy to electrical energy, and the electrical energy is used at least in-part to charge the battery.

Additionally to the foregoing embodiment, the at least one airfoil is a fan and the energy conversion device is a fan motor configured to drive the fan when in a normal operation state.

In the alternative or additionally thereto, in the foregoing embodiment, the fan motor rotates in a first direction when in a normal operational state, and rotates in an opposite second direction when the fan is exposed to wind and the transport refrigeration unit is in a battery charge state.

In the alternative or additionally thereto, in the foregoing embodiment, the fan motor is an induction motor.

In the alternative or additionally thereto, in the foregoing embodiment, the transport refrigeration unit includes a compressor constructed and arranged to compress a refrigerant; a compressor motor configured to drive the compressor; a combustion engine; and a generator mechanically driven by the combustion engine, and configured to provide electrical power to the compressor motor, wherein the battery is configured to at least provide electric power to start the combustion engine.

In the alternative or additionally thereto, in the foregoing embodiment, the transport refrigeration unit includes a condenser heat exchanger operatively coupled to the compressor, wherein the fan is a condenser fan configured to provide air flow over the condenser heat exchanger when in the normal operational state.

In the alternative or additionally thereto, in the foregoing embodiment, the transport refrigeration unit includes an evaporator heat exchanger operatively coupled to the compressor; an evaporator fan configured to provide air flow over the evaporator heat exchanger; and an evaporator fan motor for driving the evaporator fan.

In the alternative or additionally thereto, in the foregoing embodiment, the transport refrigeration unit includes an isolation relay electrically connected between the battery and the fan motor, wherein the isolation relay is adapted to be in a first position when the transport refrigeration unit is in the normal operation state and in a second position when the transport refrigeration unit is in the battery charge state.

In the alternative or additionally thereto, in the foregoing embodiment, the transport refrigeration unit includes a rectifier electrically connected between the battery and the isolation relay.

In the alternative or additionally thereto, in the foregoing embodiment, the transport refrigeration unit includes a parasitic electrical load configured to be energized regardless of whether the transport refrigeration unit is in the normal operational state.

In the alternative or additionally thereto, in the foregoing embodiment, the parasitic electrical load includes a Telematics system.

A transport refrigeration unit according to another, non-limiting, embodiment includes a condenser fan; a condenser motor adapted to drive the fan when in a normal operating state, wherein the condenser fan is adapted to be back-driven by wind when not in the normal operating state and thus back-driving the condenser motor to produce electrical energy.

Additionally to the foregoing embodiment, the transport refrigeration unit includes a battery charged by the electrical energy.

In the alternative or additionally thereto, in the foregoing embodiment, the transport refrigeration unit includes a combustion engine adapted to be started by the battery.

In the alternative or additionally thereto, in the foregoing embodiment, the transport refrigeration unit includes an isolation relay electrically connected between the battery and the condenser motor.

The foregoing features and elements may be combined in various combinations without exclusivity, unless expressly indicated otherwise. These features and elements as well as the operation thereof will become more apparent in light of the following description and the accompanying drawings. However, it should be understood that the following description and drawings are intended to be exemplary in nature and non-limiting.

### BRIEF DESCRIPTION OF THE DRAWINGS

Various features will become apparent to those skilled in the art from the following detailed description of the disclosed non-limiting embodiments. The drawings that accompany the detailed description can be briefly described as follows:

FIG. 1 is a perspective view of a tractor trailer system having a transport refrigeration unit (TRU) as one, non-limiting, embodiment of the present disclosure;

FIG. 2 is a schematic of the TRU; and

FIG. 3 is a schematic of a renewable, wind-energy, source of the TRU.

### DETAILED DESCRIPTION

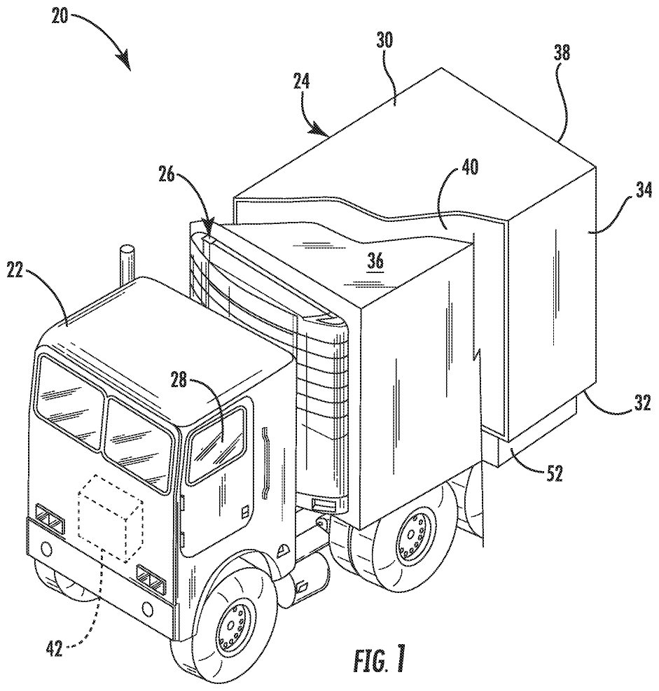

Referring to FIG. 1, a tractor trailer system 20 of the present disclosure is illustrated. The tractor trailer system 20 may include a tractor or truck 22, a trailer 24 and a transport refrigeration unit (TRU) 26. The tractor 22 may include an operator's compartment or cab 28 and a combustion engine 42 which is part of the powertrain or drive system of the tractor 22. The trailer 24 may be coupled to the tractor 22 and is thus pulled or propelled to desired destinations. The trailer may include a top wall 30, a bottom wall 32 opposed to and space from the top wall 30, two side walls 34 space from and opposed to one-another, and opposing front and rear walls 36, 38 with the front wall 36 being closest to the tractor 22. The trailer 24 may further include doors (not shown) at the rear wall 38, or any other wall. The walls 30, 32, 34, 36, 38 together define the boundaries of a cargo compartment 40. It is further contemplated and understood that the cargo compartment may also be divided into two or more smaller compartments for different temperature cargo requirements.

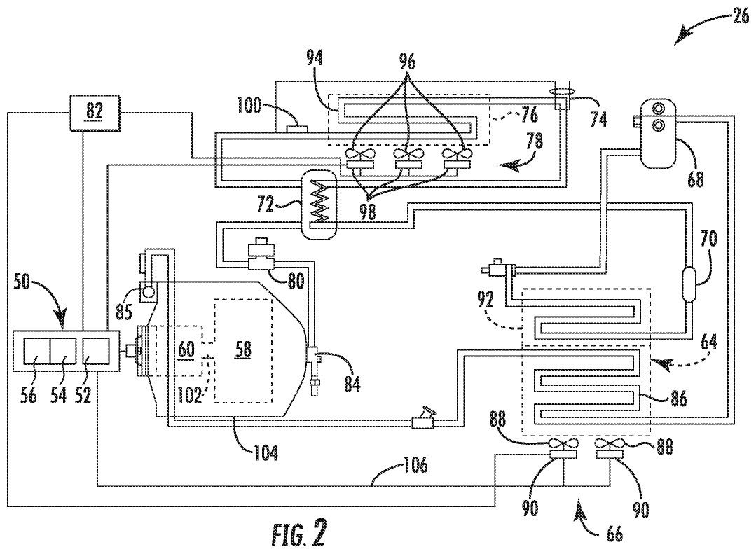

Referring to FIGS. 1 and 2, the trailer 24 is generally constructed to store a cargo (not shown) in the compartment 40. The TRU 26 is generally integrated into the trailer 24 and may be mounted to the front wall 36. The cargo is maintained at a desired temperature by cooling of the compartment 40 via the refrigeration unit 26 that circulates airflow into and through the cargo compartment 40 of the trailer 24. It is further contemplated and understood that the refrigeration unit 26 may be applied to any transport container and not necessarily those used in tractor trailer systems. Furthermore, the transport container may be the trailer 24. Alternatively, the transport container may be constructed to be removed from a framework and wheels (not shown) of the trailer 24 for alternative shipping means (e.g., marine, rail, flight, and others).

The components of the TRU 26 may include a compressor 58, an electric compressor motor 60, a condenser 64 that may be air cooled, a condenser fan assembly 66, a receiver 68, a filter dryer 70, a heat exchanger 72, a thermostatic expansion valve 74, an evaporator 76, an evaporator fan assembly 78, a suction modulation valve 80, and a controller 82 that may include a computer-based processor (e.g., microprocessor). Operation of the TRU 26 may best be understood by starting at the compressor 58, where the suction gas (i.e., natural refrigerant) enters the compressor at a suction port 84 and is compressed to a higher temperature and pressure. The refrigerant gas is emitted from the compressor 58 at an outlet port 85 and may then flow into tube(s) 86 of the condenser 64.

Air flowing across a plurality of condenser coil fins (not shown) and the tubes 86, cools the gas to its saturation temperature. The air flow across the condenser 64 may be facilitated by one or more fans 88 of the condenser fan assembly 66. The condenser fans 88 may be driven by respective condenser fan motors 90 of the fan assembly 66 that may be electric.

By removing latent heat, the gas within the tubes 86 condenses to a high pressure and high temperature liquid and flows to the receiver 68 that provides storage for excess liquid refrigerant during low temperature operation. From the receiver 68, the liquid refrigerant may pass through a subcooler heat exchanger 92 of the condenser 64, through the filter-dryer 70 that keeps the refrigerant clean and dry, then to the heat exchanger 72 that increases the refrigerant subcooling, and finally to the thermostatic expansion valve 74.

As the liquid refrigerant passes through the orifices of the expansion valve 74, some of the liquid vaporizes into a gas (i.e., flash gas). Return air from the refrigerated space (i.e., cargo compartment 40) flows over the heat transfer surface of the evaporator 76. As the refrigerant flows through a plurality of tubes 94 of the evaporator 76, the remaining liquid refrigerant absorbs heat from the return air, and in so doing, is vaporized.

The evaporator fan assembly 78 includes one or more evaporator fans 96 that may be driven by respective fan motors 98 that may be electric. The air flow across the evaporator 76 is facilitated by the evaporator fans 96. From the evaporator 76, the refrigerant, in vapor form, may then flow through the suction modulation valve 80, and back to the compressor 58. A thermostatic expansion valve bulb sensor 100 may be located proximate to an outlet of the evaporator tube 94. The bulb sensor 100 is intended to control the thermostatic expansion valve 74, thereby controlling refrigerant superheat at an outlet of the evaporator tube 94. It is further contemplated and understood that the above generally describes a single stage vapor compression system that may be used for natural refrigerants such as propane and ammonia. Other refrigerant systems may also be applied that use carbon dioxide (CO2) refrigerant, and that may be a two-stage vapor compression system.

The compressor 58 and the compressor motor 60 may be linked via an interconnecting drive shaft 102. The compressor 58, the compressor motor 60 and the drive shaft 102 may all be sealed within a common housing 104. In some embodiments, the compressor motor 60 may be positioned outside of the compressor housing 104, and therefore the interconnecting drive shaft 102 may pass through a shaft seal located in the compressor housing. The compressor 58 may be a single compressor. The single compressor may be a two-stage compressor, a scroll-type compressor or other compressors adapted to compress natural refrigerants. The natural refrigerant may be CO2, propane, ammonia, or any other natural refrigerant that may include a global-warming potential (GWP) of about one (1).

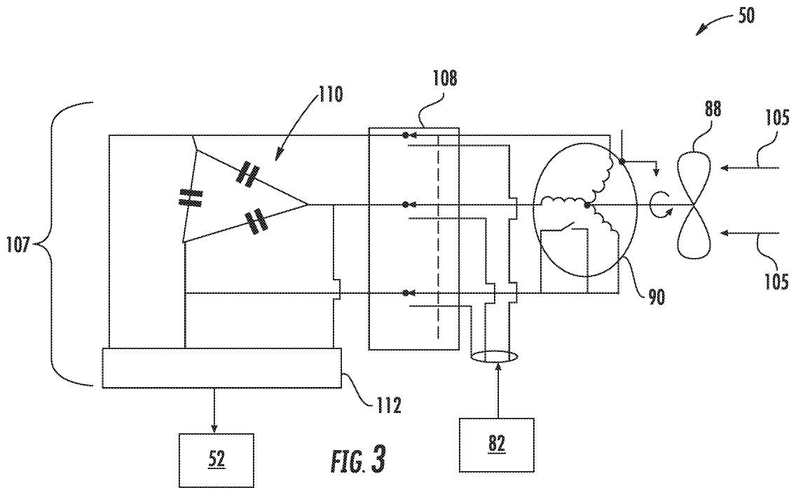

Referring to FIGS. 2 and 3, the TRU 26 further includes a multiple energy source 50 configured to selectively power the compressor motor 60, the condenser fan motors 90, the evaporator fan motors 98, the controller 82, and other components 99 (see FIG. 3), which may include various solenoids and/or sensors, via, for example, electrical conductors 106. The multiple energy source 50 may include an energy storage device 52, and a generator 54 mechanically driven by a combustion engine 56 that may be part of, and dedicated to, the TRU 26. The energy storage device 52 may be at least one battery. In one embodiment, the battery 52 may be configured to provide direct current (DC) electric power to one or both of the evaporator and condenser fan motors 98, 90, while the generator 54 provides electrical power to the compressor motor 60. The electric power provided to the compressor motor 60 may be alternating current (AC) or DC with the associated configuration of inverters and/or converters (not shown) typically known in the art. Accordingly, the compressor motor 60 may be an AC motor or a DC motor. The fan motors 90, 98 may be DC motors corresponding to the DC power provided by the battery 52. In one embodiment, the energy storage device 52 may be secured to the underside of the bottom wall 32 of the trailer 24 (see FIG. 1). It is further contemplated and understood that other examples of the energy storage device 52 may include fuel cells, and other devices capable of storing and outputting DC power.

The condenser 64 is generally designed for free air flow from the outside of the cargo compartment 24. That is, outside ambient air may be free to flow over or through the condenser 64 and fans 90, and out the top and/or the bottom of the TRU 26. Such airflow may be induced by wind (see arrows 105 in FIG. 3), and may occur when the TRU 26 is not in an operational state and/or the TRU 26 and the cargo container 24 is generally sitting idle (e.g., placed in a storage facility, etc.). When sitting idle, the battery 52 may discharge over time and/or may become depleted by providing low amounts of power to parasitic loads over, for example, extended periods of time. Examples of parasitic loads may include the controller 82 and various sensors. The controller 82 may further include remote systems (e.g., a Telematics system) configured to maintain a wireless, two-way, communication with the segment of the controller 82 that may be local (i.e., proximate to the TRU 26).

Referring to FIG. 3, the multiple energy source 50 may include a renewable, wind energy, source 107 that may utilize one or more of the condenser fans 88 and fan motors 90 as generators (i.e., two illustrated in FIG. 2). The condenser fan motors 90 may be induction motors and may be AC or DC motors (i.e., illustrated as AC motors). In this embodiment, the condenser fan motors 90 may be described as energy conversion devices because they serve a dual purpose as motors and generators; and, the associated condenser fans 88 may be described as a plurality of airfoils because they serve a dual purpose as fans and turbines.

When the TRU 26 is operating in a normal operating state (i.e., conditioning air in the cargo compartment), the energy conversion device 90 function as a motor and the plurality of airfoils 88 are mechanically driven by the motor 90 thus functioning as a fan. When the TRU 26 is generally idle and operating in a battery charging state, the plurality of airfoils 88 function as a turbine that mechanical drives the energy conversion device 90 that acts as a generator to produce electrical energy that may charge the battery 52. That is, wind may drive the airfoils 88, and thus the energy conversion device 90 in a reverse direction.

This renewable, wind-energy, source 107 may be used to conveniently, and cost effectively, charge the battery 52. The renewable, wind-energy, source 107 may include an isolation relay 108, an excitation capacitor, or capacitor bank, 110, and a rectifier 112 that may be, or may be part of, a regulator battery charger. The circuit may be arranged with the isolation relay 108 electrically connected between the motor(s) 90 and the excitation capacitor bank 110. The capacitor bank 110 may be electrically connected between the isolation relay 108 and the rectifier 112.

When the energy conversion device 90 is being ‘back-driven’ by wind, the device generates electricity by using residual magnetism in the motor rotor (not shown) and the excitation capacitor bank 110. In another embodiment, a small excitation voltage may be used. That is, a small voltage may be applied to excite the magnetic field in the motor windings thus starting the power generation once there is rotation. If the residual magnetism is used, the self-generated voltage may be relatively small and the capacitor bank 110 may assist in boosting this voltage. If the energy conversion device 90 is an AC motor, the AC power generated by the back-driven motor, or device, 90 may be rectified by the rectifier 112 to DC power and used to recharge the battery 52. It is further contemplated and understood that the energy conversion device 90 may generally be a DC motor capable of generating electricity when back-driven. In this embodiment, the wind-energy source 107 may not require the rectifier 112 to charge the battery 52. Instead, a voltage regulator may be used to condition the generated electricity.

The isolation relay 108 may function to keep the normal operating state of the TRU 26 separate from the wind-energy battery charging state. More specifically, the isolation relay 108 may be in a first position (e.g., open position) when the TRU 26 is in the normal operating state (i.e., conditioning the air in the cargo compartment), and may be in a second position (e.g., closed position) when the TRU is in the battery charging state.

Referring again to FIG. 2, the controller 82 may generally control the position of the relay 108. Alternatively, the relay position may be switched manually. In another embodiment, the renewable wind-energy source 107 may be independent from the condenser fans 88 and condenser motors 90. For example, wind-energy source 107 may include a dedicated turbine and a dedicated generator to produce electrical power that may be used to charge the battery 52 and/or operate other components of the TRU 26, and regardless of whether the TRU 26 is in the normal operating state or the battery charging state.

Benefits and advantages of the present disclosure includes an efficient, cost effective, and convenient means to charge a battery of a TRU. By maintaining a charged battery, robustness of the TRU and starting confidence is improved, and service calls are minimized.

While the present disclosure is described with reference to the figures, it will be understood by those skilled in the art that various changes may be made and equivalents may be substituted without departing from the spirit and scope of the present disclosure. In addition, various modifications may be applied to adapt the teachings of the present disclosure to particular situations, applications, and/or materials, without departing from the essential scope thereof. The present disclosure is thus not limited to the particular examples disclosed herein, but includes all embodiments falling within the scope of the appended claims.

What is claimed is:

1. A transport refrigeration unit comprising:
at least one airfoil;
an energy conversion device attached to the airfoil, wherein the at least one airfoil is constructed and arranged to mechanically drive the energy conversion device upon exposure to wind, the energy conversion device is constructed and arranged to convert mechanical energy to electrical energy, and the electrical energy is used at least in-part to charge the battery.

2. The transport refrigeration unit set forth in claim 1, wherein the at least one airfoil is a fan and the energy conversion device is a fan motor configured to drive the fan when in a normal operation state.

3. The transport refrigeration unit set forth in claim 2, wherein the fan motor rotates in a first direction when in a normal operational state, and rotates in an opposite second direction when the fan is exposed to wind and the transport refrigeration unit is in a battery charge state.

4. The transport refrigeration unit set forth in claim 3, wherein the fan motor is an induction motor.

5. The transport refrigeration unit set forth in claim 3, further comprising:
a compressor constructed and arranged to compress a refrigerant;
a compressor motor configured to drive the compressor;
a combustion engine; and
a generator mechanically driven by the combustion engine, and configured to provide electrical power to the compressor motor, wherein the battery is configured to at least provide electric power to start the combustion engine.

6. The transport refrigeration unit set forth in claim 5, further comprising:
a condenser heat exchanger operatively coupled to the compressor, wherein the fan is a condenser fan configured to provide air flow over the condenser heat exchanger when in the normal operational state.

7. The transport refrigeration unit set forth in claim 6, further comprising:
an evaporator heat exchanger operatively coupled to the compressor;
an evaporator fan configured to provide air flow over the evaporator heat exchanger; and
an evaporator fan motor for driving the evaporator fan.

8. The transport refrigeration unit set forth in claim 7, wherein the battery is configured to provide electric power to the condenser and evaporator fan motors.

9. The transport refrigeration unit set forth in claim 6, further comprising:
an isolation relay electrically connected between the battery and the fan motor, wherein the isolation relay is adapted to be in a first position when the transport refrigeration unit is in the normal operation state and in a second position when the transport refrigeration unit is in the battery charge state.

10. The transport refrigeration unit set forth in claim 9, further comprising:
a rectifier electrically connected between the battery and the isolation relay.

11. The transport refrigeration unit set forth in claim 10, further comprising:
a parasitic electrical load configured to be energized regardless of whether the transport refrigeration unit is in the normal operational state.

12. The transport refrigeration unit set forth in claim 11, wherein the parasitic electrical load includes a Telematics system.

13. A transport refrigeration unit comprising:
a condenser fan;
a condenser motor adapted to drive the fan when in a normal operating state, wherein the condenser fan is adapted to be back-driven by wind when not in the normal operating state and thus back-driving the condenser motor to produce electrical energy.

14. The transport refrigeration unit set forth in claim 13, further comprising:
a battery charged by the electrical energy.

15. The transport refrigeration unit set forth in claim 14, further comprising:
a combustion engine adapted to be started by the battery.

16. The transport refrigeration unit set forth in claim 15, further comprising:
an isolation relay electrically connected between the battery and the condenser motor.
